(19) United States
(12) Patent Application Publication
(10) Pub. No.: US 2024/0351561 A1
(43) Pub. Date: Oct. 24, 2024

(54) NON-MECHANICAL AIRCRAFT RESTRAINT

(71) Applicant: Jeffrey Lavoie, Belmont, NH (US)

(72) Inventor: Jeffrey Lavoie, Belmont, NH (US)

(21) Appl. No.: 18/305,593

(22) Filed: Apr. 24, 2023

(51) Int. Cl. B60T 3/00; B64F 1/16

(52) U.S. Cl. CPC B60T 3/00; B64F 1/16

(57) ABSTRACT

The system for restraining aircraft wheels using at least one body having a rounded top surface and a squared bottom edge connected via a pair of sloped side walls. A pair of bodies being secured along a length of reflective rope. At least a bottom surface of the body being made of a material having a coefficient of friction sufficient to prevent sliding on a surface to prevent movement of the aircraft wheels.

### FIELD OF THE DISCLOSURE

The present disclosure relates to restraints for aircraft and more particularly to non-mechanical, anti-slip, light weight aircraft restraints.

### BACKGROUND OF THE DISCLOSURE

Aircraft typically have two or more wheels that need to be stabilized when the aircraft is on land. Wheel restraints may be mechanical (e.g., hydraulic), may engage automatically when the engine is shut off, be fixed in a location, or be non-mechanical. Wheel restraints are often made of materials such as plastic, rubber or wood. By using heavy materials the wheel is less likely to move when the restraint is in place. Substantial movement of the vehicle during the loading and unloading thereof, can cause serious accidents and sometimes death. Many wheel restraints are triangular in cross section and in some cases, one of the surfaces extending upwardly from the base of the restraint may have a curvature complementary to the curvature of the aircraft wheel. Moveable restraints are placed in front of and/or in back of an aircraft's wheels to prevent the aircraft from rolling out of position. It is important for the restraints to be visible so that once the aircraft has been loaded the pilot does not inadvertently drive over the restraint.

Wherefore it is an object of the present disclosure to overcome the above-mentioned shortcomings and drawbacks associated with the conventional aircraft restraints.

### SUMMARY OF THE DISCLOSURE

Wheel restraints are typically heavy and smooth and they can slide out of position once placed-creating a dangerous situation. The non-mechanical wheel restraints disclosed herein light-weight, anti-slip (high coefficient of friction), and visible at night.

One aspect of the present disclosure is a restraint, including: a body having a height, a width, and a length; the body having a rounded top surface and a squared bottom edge, wherein the rounded top surface and the squared bottom edge are connected via a pair of sloping side walls; and the body forming at least one internal cavity coaxial with and extending the length of the body.

In some implementations, the techniques described herein relate to a restraint, wherein the body is included of a top portion and a bottom portion. In some aspects, the techniques described herein relate to a restraint, wherein the top portion and the bottom portion are slidably engaged. In some aspects, the techniques described herein relate to a restraint, wherein the bottom portion of the body is included of rubber.

In some implementations, the techniques described herein relate to a restraint, wherein the top portion of the body is included of aluminum. In some aspects, the techniques described herein relate to a restraint, wherein the at least one internal cavity is sized to accommodate a rope. In some aspects, the techniques described herein relate to a restraint, wherein the rope is reflective.

Another aspect of the present disclosure is a restraint, including: a body including, a top portion, the top portion having a height, a width, and a length; wherein the top portion has a rounded top surface and a squared bottom edge, the rounded top surface and the squared bottom edge being connected via a pair of sloping side walls, and the top portion forming at least one internal cavity coaxial with and extending the length of the body; and a bottom portion, wherein the top portion and the bottom portion are slidably engaged.

In some implementations, the techniques described herein relate to a restraint, wherein the bottom portion of the body is included of rubber. In some aspects, the techniques described herein relate to a restraint, wherein the top portion of the body is included of aluminum. In some aspects, the techniques described herein relate to a restraint, wherein the at least one internal cavity is sized to accommodate a rope. In some aspects, the techniques described herein relate to a restraint, wherein the rope is reflective.

In some aspects, the techniques described herein relate to a restraint, wherein slidable engagement between the top portion and the bottom portion is provided via one or more protrusions and one or more indentations.

Yet another aspect of the present disclosure is a restraint system, including: a pair of restraints, each restraint including: a body having a height, a width, and a length; the body having a rounded top surface and a squared bottom edge, wherein the rounded top surface and the squared bottom edge are connected via a pair of sloping side walls; the body forming at least one internal cavity coaxial with and extending the length of the body; and a rope sized to fit within the at least one internal cavity.

In some implementations, the techniques described herein relate to a restraint system, wherein the body is included of a top portion and a bottom portion. In some aspects, the techniques described herein relate to a restraint system, wherein the top portion and the bottom portion are slidably engaged. In some aspects, the techniques described herein relate to a restraint system, wherein the bottom portion of the body is included of rubber. In some aspects, the techniques described herein relate to a restraint system, wherein the top portion of the body is included of aluminum.

In some aspects, the techniques described herein relate to a restraint system, wherein the at least one internal cavity is sized to accommodate the rope such that each body is secured along a length of the rope using a knot on either side of each body. In some aspects, the techniques described herein relate to a restraint system, wherein the rope is reflective.

These aspects of the disclosure are not meant to be exclusive and other features, aspects, and advantages of the present disclosure will be readily apparent to those of ordinary skill in the art when read in conjunction with the following description, appended claims, and accompanying drawings.

### BRIEF DESCRIPTION OF THE DRAWINGS

The foregoing and other objects, features, and advantages of the disclosure will be apparent from the following description of particular implementations of the disclosure, as illustrated in the accompanying drawings in which like reference characters refer to the same parts throughout the different views. The drawings are not necessarily to scale, emphasis instead being placed upon illustrating the principles of the disclosure.

FIG. 1 shows a cross section of one implementation of a non-mechanical aircraft restraint according to the principles of the present disclosure.

FIG. 2 shows a cross section of another implementation of a non-mechanical aircraft restraint according to the principles of the present disclosure.

FIG. 3A shows a cross section of a top portion of an implementation of a non-mechanical aircraft restraint according to the principles of the present disclosure.

FIG. 3B shows a cross section of a bottom portion of an implementation of a non-mechanical aircraft restraint according to the principles of the present disclosure.

FIG. 4 shows a perspective view of an implementation of a pair of non-mechanical aircraft restraints according to the principles of the present disclosure.

FIG. 5 shows a perspective view of an implementation of a pair of non-mechanical aircraft restraints on either side of an aircraft wheel having a low wheel skirt according to the principles of the present disclosure.

### DETAILED DESCRIPTION OF THE DISCLOSURE

It has been recognized that wheel restraints are heavy and smooth can slide out of position once placed. This creates a dangerous situation. One implementation of the present disclosure is a non-mechanical restraint for aircraft that is light-weight, anti-slip (high coefficient of friction), and visible at night.

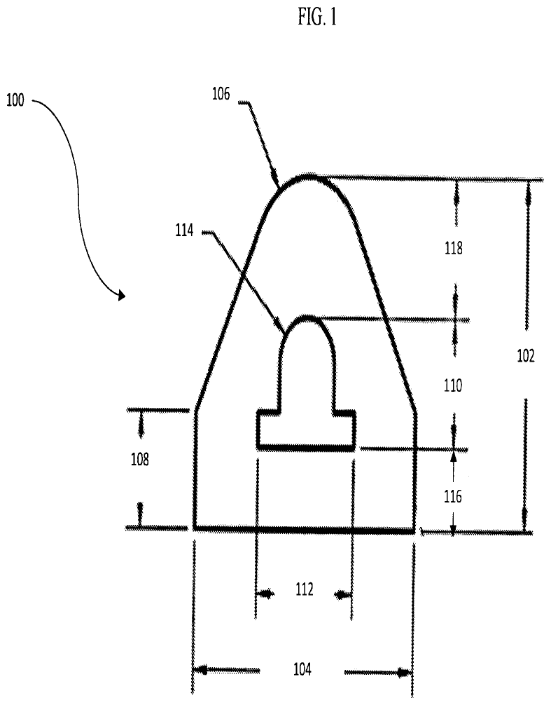

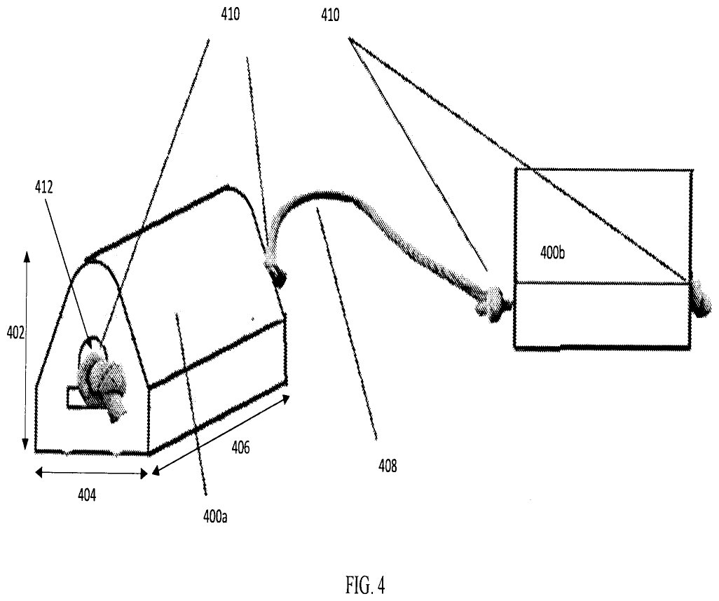

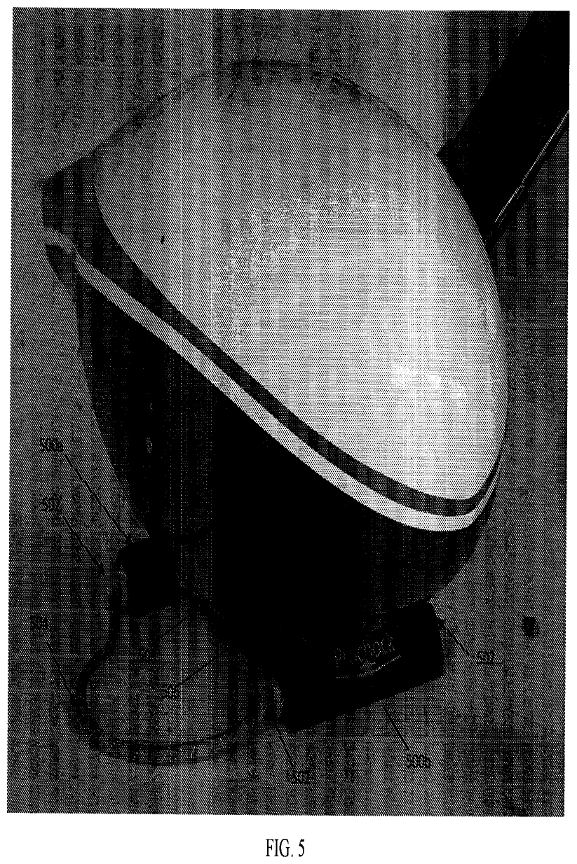

Referring to FIG. 1, a cross section of one implementation of a non-mechanical aircraft restraint of the present disclosure is shown. More specifically, one implementation of a non-mechanical aircraft restraint 100 has a height 102 and a width 104. In some implementations, the height is about 1.875 inches and the width is about 2 inches. The non-mechanical aircraft restraints of the present disclosure also have a length (See, e.g., FIGS. 4 and 5). In certain implementations, the restrain has a length of about 8 inches to cover a typical general aviation aircraft tire width. In some implementations, a top surface 106 of the restraint is curved. In some implementations, the radius of curvature is 0.5 inches. By curving the top surface, the amount of material needed is reduced and so is the weight of the restraint. In some implementations, a bottom surface meets the side surfaces at about a 90° angle. In some cases, this squared portion has a height of about 0.625 inches from the bottom surface of the restraint. The rounded top and the squared bottom reduce the overall footprint of the restraint as the tire of an aircraft meets the slope point of the restraint, and not at the ground. This allows for reduced width of the restraint need to be effective, and helps to reduce the overall weight of the restraint. Cargo space and cargo weight are limited on aircraft. These restraints provide for improved functionality at a reduced size and weight. In certain implementations, the shape of the restrain has vertical sides instead of a typical triangle shape to reduce materials (weight/cost) to accomplish the same effect and the rounded top, was chosen to keep a low profile to fit under low wheel pants of aircraft to prevent any damage or getting stuck between a wheel pant and a tire.

Still referring to FIG. 1, certain implementations of the non-mechanical aircraft restraint have an internal cavity 114 having a height 110 and being coaxial with the length of the restraint. In some cases, the top surface of the internal cavity is curved. In certain implementations, the radius of curvature for the top surface of the internal cavity is about 0.25 inches. In one implementation of the non-mechanical aircraft restraint, the internal cavity as a width 112. In certain implementations, the internal cavity mimics the shape of the restraint, and in other cases, it has a different profile in cross-section. In some implementations, the internal cavity is located a distance above 116 the bottom surface of the restraint, and a distance below 118 the top surface of the restraint.

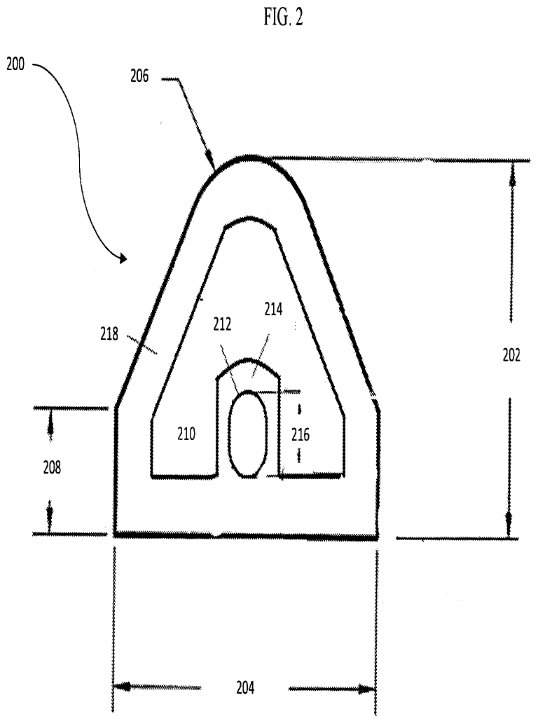

Referring to FIG. 2, a cross section of another implementation of a non-mechanical aircraft restraint of the present disclosure is shown. More specifically, one implementation of a non-mechanical aircraft restraint 200 has a height 202 and a width 204. In some implementations, the height is about 4 inches and the width is about 4.25 inches. The non-mechanical aircraft restraints of the present disclosure also have a length (See, e.g., FIGS. 4 and 5). In certain implementations, the restraint has a length of about 8 inches. In some implementations, the length of the restraint is up to about 16-20 inches to support tires for aircraft that are dually (2 tires on landing gear support). In certain implementations, the longer restraints may also have greater heights and widths as compared to shorter restraints to support larger aircraft. In some implementations, a top surface 206 of the restraint is curved. In some implementations, the radius of curvature is 0.75 inches. By curving the top surface, the amount of material needed is reduced and so is the weight of the restraint. In some implementations, a bottom surface meets the side surfaces at about a 90° angle. In some cases, this squared portion has a height of about 1.25 inches from the bottom surface of the restraint. The rounded top and the squared bottom reduce the overall footprint of the restraint as the tire of an aircraft meets the slope point of the restraint, and not at the ground. This allows for reduced width of the restraint need to be effective, and helps to reduce the overall weight of the restraint.

Still referring to FIG. 2, certain implementations of the non-mechanical aircraft restraint have a first internal cavity 210 being coaxial with the length of the restraint. In certain implementations, the first internal cavity is formed within walls 218 of the restraint 200. In some implementations, there is a second internal cavity 212 having a height 216 that is firmed within the first internal cavity formed by a cavity wall 214. In certain implementations, the cavity wall 214 has a thickness of about 0.375 inches. The second internal cavity is also coaxial with the length of the restraint. In some cases, the top surface of the second internal cavity is curved. In certain implementations, the radius of curvature for the top surface of the second internal cavity is about 0.25 inches. In one implementation of the non-mechanical aircraft restraint, the first internal cavity has a height. In certain implementations, the first internal cavity mimics the shape of the restraint, and in other cases, it has a different profile in cross-section. In some implementations, in internal cavity shape where the rope feeds through is to save on weight/cost. In some implementations, the first internal cavity is located a distance above and a distance below the top surface of the restraint represented by a thickness of the wall 218. In certain implementations the thickness is 0.5 inches.

Certain implementations of the non-mechanical aircraft restraint of the present disclosure provides durability while reducing the space/weight required. In some implementations, the outer surface is smooth and makes lettering/personalizing the restraint with a vinyl application possible.

Implementations of the non-mechanical aircraft restraint of the present disclosure may be constructed of rubber. In some cases, the shape allows for rope to be placed and secured through the restraint. In some cases, a 75 Durometer EPDM is used. Alternative types of material may also be used to create the restraint. The 75 Durometer EPDM rubber material has a high density making it durable in handling the weight of an airplane tire being rolled against it. The hardness level of the material is chosen to provide a more durable restraint while at the same time reducing the amount of sliding (or moving) on a tarmac or hangar floor. The material is chosen to be soft enough to increase the coefficient of friction (COF) to provide a ‘stickiness’ to the restraint to help it remain in place from accidental kicks, gusts of wind, and the like. As the hardness of a material increases, the coefficient of external friction decreases, due to a decrease in both the adhesive and deformation components of the coefficient.

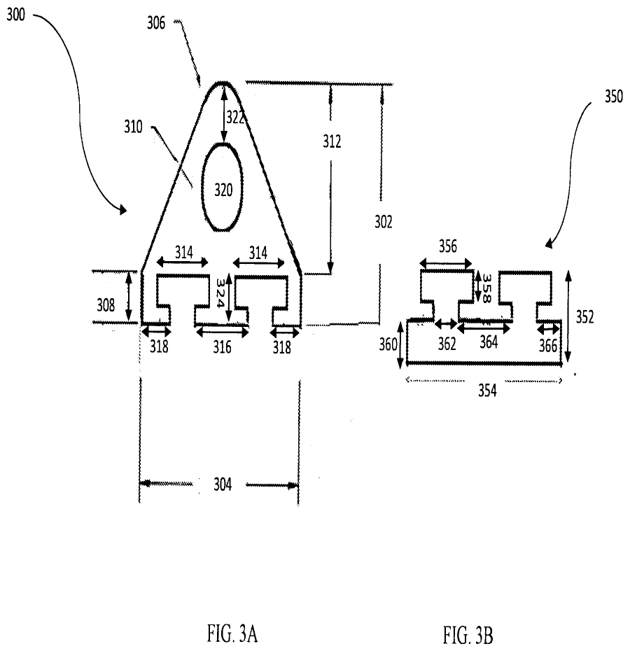

One implementation of a two piece non-mechanical aircraft restraint is shown in FIG. 3A and FIG. 3B. In certain implementations, a two piece non-mechanical aircraft restraint provides an aluminum wheel restraint option for those who have this preference while not compromising the stickiness (COF) of the restraint, the bottom section e.g., shown in FIG. 3B is made of the same material used in the restraints shown in at least FIG. 1 and FIG. 2. Aluminum is very slippery and thus restraints of this materials can easily slide around. With the two piece design of the present disclosure, the look and feel individuals like of aluminum restraints is provided while maintaining the performance of the stickiness of the restraint by having an insert secured and used for contact on the ground.

Referring to FIG. 3A, a cross section of a top portion of an implementation of a non-mechanical aircraft restraint of the present disclosure is shown. More specifically, an implementation of a top portion 300 of a two piece non-mechanical aircraft restraint has a height 302, a width 304 and a rounded top surface 306. In some implementations, the height is about 1.56 inches and the width is about 2 inches. The non-mechanical aircraft restraints of the present disclosure also have a length (See, e.g., FIGS. 4 and 5). In some implementations, a top surface 306 of the restraint is curved. In some implementations, the radius of curvature is 0.25 inches. By curving the top surface, the amount of material needed is reduced and so is the weight of the restraint. In some implementations, a bottom surface meets the side surfaces at about a 90° angle. In some cases, this squared portion has a height of about 0.31 inches from the bottom surface of the restraint. The rounded top and the squared bottom reduce the overall footprint of the restraint as the tire of an aircraft meets the slope point of the restraint, and not at the ground. This allows for reduced width of the restraint needed to be effective, and helps to reduce the overall weight of the restraint. In some cases, the top portion 300 is constructed of metal. In some cases, the metal is aluminum.

Still referring to FIG. 3A, certain implementations of the non-mechanical aircraft restraint has an internal cavity 320 being coaxial with the length of the restraint. In certain implementations, the internal cavity is formed within walls 310 of the top portion of the restraint 300. In one implementation of the non-mechanical aircraft restraint, the internal cavity has a height. In certain implementations, the first internal cavity mimics the shape of the restraint, and in other cases, it has a different profile in cross-section. In some cases, it is rounded and has a radius of curvature of about 0.25 inches. In some implementations, the internal cavity is located a distance below 322 the top surface of the restraint. In certain implementations the thickness is 0.31 inches.

Certain implementations of the two portions of the non-mechanical aircraft restraint of the present disclosure are slidably engaged with each other. In one implementation, one or more indentations are present on one portion and they mate with one or more protrusions on the other potion. In FIG. 3A, one implementation of indentations is shown. There a pair of indentations are shown each having a height 324, a width 314, and spacing 318, 316 along the bottom surface of the top portion 300 of the restraint. In some cases, the indentations are spaced a distance 312 from the top surface of the top portion of the restraint. Here, the indentations are shown as T shaped, but other shapes are possible.

Referring to FIG. 3B, a cross section of a bottom portion of an implementation of a non-mechanical aircraft restraint of the present disclosure is shown. More specifically, the bottom portion 350 of a two piece non-mechanical aircraft restraint has a height 352, a width 354. In an implementation where there are one or more indentations on the top portion 300, one or more protrusions are present on the bottom portion 350 to slidably engage with the top portion. The protrusions and indentions runs coaxially with the length of the restraint so that the top and bottom portions can be engaged and disengaged from each other, as needed. In certain implementation, the bottom portion 350 is constructed of rubber material having durability and stickiness as described previously.

Still referring to FIG. 3B, one or more protrusions are present on one portion and they mate with one or more indentations on the other potion. In FIG. 3B, one implementation of protrusions is shown. There a pair of protrusions are shown each having a thickness 358, a width 356, and spacing 362, 364, 366 along the width of the bottom portion 350 of the restraint. In some cases, the protrusions are spaced a distance 360 from the bottom surface of the bottom portion of the restraint. Here, the protrusions are shown as T shaped, but other shapes are possible.

Referring to FIG. 4, a perspective view of an implementation of a pair of non-mechanical aircraft restraints of the present disclosure is shown. More specifically, each implementation of the non-mechanical aircraft restraint 400a, 400b has a height 402, a width 404 and a length 406. A length of rope 408 can be seen passing through the internal cavity 412 of each restraint. In certain implementations of the present disclosure, the rope is knotted 410 to hold the restraints at a particular distance from each other and to minimize the restraints ability to move along the length of the rope, or the like. In some cases 4 knots are used to secure the restraints onto the rope, or the like.

In certain implementations, the shape of the restrain, having vertical sides and a rounded top reduce the amount of material and saves weight, but at the same times adds more durability/structural integrity to the wheel restraint. Most restraints are a triangle shape. The present disclosure has a flat bottom surface with a bottom 90° wall so an aircraft wheel interacts with the restraint at the restraint's sloped side therefore removing wasted space and weight at the bottom of the restraint bringing the slope to a rounded top also allows for the restraint 500a, 500b to easily fit under aircraft that have low wheel pants 508. See, FIG. 5.

Referring to FIG. 5, a perspective view of an implementation of a pair of non-mechanical aircraft restraints on either side of an aircraft wheel having a low wheel pants according to the principles of the present disclosure is shown. More specifically, a dual heat transfer system may be used to apply vinyl to the restraints 500a, 500b to make identification easier and to provide for branding and customization. Certain implementations of the non-mechanical aircraft restraint of the present discourse use a pair of rubber restraints 500a, 500b with reflective roping 504 held together by a 4 knot 502 system to secure aircraft wheels 506 from moving back or forth. The 4 knot system makes it easy to adjust the spacing of the restraints, easily replace restraints, and also give night time visibility by using reflective roping that secures the wheel restraints in place by an outside and inside knot. In some cases, a reflective paracord rope is used to give night time visibility. In some cases, the roping is UV/Mold resistant reflective material for durability and sustainability.

In certain implementations, an outside knot and an inside knot are sued to secure the restraint along the length of the rope, or the like, but also make it easy to replace or adjust length of the restraint assembly. In some case, the restraints may be secured using other methods than knots.

The use of reflective rope or the like increases safety for pilots at night. For example, loose restraints get moved around during the day, and sometimes pilots forget their restraints when they take off. Due to the reflective nature of the connective rope, unsuspecting pilots, parking their planes at night are less likely to roll over them since they are visible due to the reflective nature of the rope. The composition of the material used on at least the bottom portion of the restraint provides increased durability to the restraint, while the hardness level of the restraint is below that of a hockey puck. This enables the restraints to resist sliding on a tarmac, or on the floor of a hangar, either from kicking them or from gusts of wind moving them out of place. The slightly softer material provides for a higher coefficient of friction, which results in a “grippiness” to the restraint that pilots desire.

Reflective rope holds the two restraints in place (knotted on both sides of each to secure them from sliding around, makes the overall restraint visible at night for ease of locating the plane with a nighttime visual of where the wheels 506 are and reducing the risk of a person walking into a propeller at night, and increasing safety from unsuspecting pilots riding over restraints they can't see at night in the darkness. In some cases, a ⅜″ inch rope, or the like, is used. The rope is durable and helps the restraint to stay in place due to added friction on the ground with more rope coming in contact with any surface the plane may be parked on. In some cases, the rope is UV and Rot resistant to increase it's durability.

In certain implementations, the length of the restraint ranges from about 6 inches to about 10 inches. In certain implementations, the length of the restraint ranges from about 16 inches to about 20 inches. In one implementation the length of the restraint is about 6 inches, about 7 inches, about 8 inches, about 9 inches, about 10 inches, about 11 inches, or about 12 inches. In one implementation the length of the restraint is about 13 inches, about 14 inches, about 15 inches, about 16 inches, about 17 inches, about 18 inches, about 19 inches, or about 20 inches.

In certain implementations, the height of the restraint is less than the width of the restraint. In certain implementations, the height of the restraint ranges from about 1.5 inches to about 8 inches. In certain implementations, the height of the restraint ranges from about 1.5 inches to about 4 inches. In one implementation the height of the restraint is about 1.5 inches, about 1.75 inches, about 2 inches, about 2.25 inches, about 2.5 inches, about 2.75 inches, or about 3 inches. In one implementation the height of the restraint is about 3.25 inches, about 3.5 inches, about 3.75 inches, about 4 inches, about 4.25 inches, about 4.5 inches, about 4.75 inches, or about 5 inches. In one implementation the height of the restraint is about 5.25 inches, about 5.5 inches, about 5.75 inches, about 6 inches, about 6.25 inches, about 6.5 inches, about 6.75 inches, or about 7 inches. In one implementation the height of the restraint is about 7.25 inches, about 7.5 inches, about 7.75 inches, or about 8 inches.

In certain implementations, the width of the restraint ranges from about 1.75 inches to about 8.5 inches. In certain implementations, the width of the restraint ranges from about 1.75 inches to about 4.5 inches. In one implementation the width of the restraint is about 1.75 inches, about 2 inches, about 2.25 inches, about 2.5 inches, about 2.75 inches, or about 3 inches. In one implementation the width of the restraint is about 3.25 inches, about 3.5 inches, about 3.75 inches, about 4 inches, about 4.25 inches, about 4.5 inches, about 4.75 inches, or about 5 inches. In one implementation the width of the restraint is about 5.25 inches, about 5.5 inches, about 5.75 inches, about 6 inches, about 6.25 inches, about 6.5 inches, about 6.75 inches, or about 7 inches. In one implementation the width of the restraint is about 7.25 inches, about 7.5 inches, about 7.75 inches, about 8 inches, about 8.25 inches, or about 8.5 inches.

Various inventive concepts may be embodied as one or more methods, of which an example has been provided. The acts performed as part of the method may be ordered in any suitable way. Accordingly, implementations may be constructed in which acts are performed in an order different than illustrated, which may include performing some acts simultaneously, even though shown as sequential acts in illustrative implementations.

While various inventive implementations have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive implementations described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive implementations described herein. It is, therefore, to be understood that the foregoing implementations are presented by way of example only and that, within the scope of the appended claims and equivalents thereto, inventive implementations may be practiced otherwise than as specifically described and claimed. Inventive implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one implementation, to A only (optionally including elements other than B); in another implementation, to B only (optionally including elements other than A); in yet another implementation, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one implementation, to at least one, optionally including more than one, A, with no B present (and optionally including elements other than B); in another implementation, to at least one, optionally including more than one, B, with no A present (and optionally including elements other than A); in yet another implementation, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one implementation, the features and elements so described or shown can apply to other implementations. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An implementation is an implementation or example of the present disclosure. Reference in the specification to “an implementation,” “one implementation,” “some implementations,” “one particular implementation,” “an exemplary implementation,” or “other implementations,” or the like, means that a particular feature, structure, or characteristic described in connection with the implementations is included in at least some implementations, but not necessarily all implementations, of the invention. The various appearances “an implementation,” “one implementation,” “some implementations,” “one particular implementation,” “an exemplary implementation,” or “other implementations,” or the like, are not necessarily all referring to the same implementations.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, the method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

While the principles of the disclosure have been described herein, it is to be understood by those skilled in the art that this description is made only by way of example and not as a limitation as to the scope of the disclosure. Other implementations are contemplated within the scope of the present disclosure in addition to the exemplary implementations shown and described herein. Modifications and substitutions by one of ordinary skill in the art are considered to be within the scope of the present disclosure.

What is claimed:

1. A restraint, comprising:
a body having a height, a width, and a length;
the body having a rounded top surface and a squared bottom edge, wherein the rounded top surface and the squared bottom edge are connected via a pair of sloping side walls; and
the body forming at least one internal cavity coaxial with and extending the length of the body.

2. The restraint according to claim 1, wherein the body is comprised of a top portion and a bottom portion.

3. The restraint according to claim 2, wherein the top portion and the bottom portion are slidably engaged.

4. The restraint according to claim 3, wherein the bottom portion of the body is comprised of rubber.

5. The restraint according to claim 3, wherein the top portion of the body is comprised of aluminum.

6. The restraint according to claim 1, wherein the at least one internal cavity is sized to accommodate a rope.

7. The restraint according to claim 6, wherein the rope is reflective.

8. A restraint, comprising:
a body comprising,
a top portion, the top portion having a height, a width, and a length;
wherein the top portion has a rounded top surface and a squared bottom edge, the rounded top surface and the squared bottom edge being connected via a pair of sloping side walls, and the top portion forming at least one internal cavity coaxial with and extending the length of the body; and
a bottom portion, wherein the top portion and the bottom portion are slidably engaged.

9. The restraint according to claim 8, wherein the bottom portion of the body is comprised of rubber.

10. The restraint according to claim 8, wherein the top portion of the body is comprised of aluminum.

11. The restraint according to claim 8, wherein the at least one internal cavity is sized to accommodate a rope.

12. The restraint according to claim 11, wherein the rope is reflective.

13. The restraint according to claim 8, wherein slidable engagement between the top portion and the bottom portion is provided via one or more protrusions and one or more indentations.

14. A restraint system, comprising:
a pair of restraints, each restraint comprising:
a body having a height, a width, and a length;
the body having a rounded top surface and a squared bottom edge, wherein the rounded top surface and the squared bottom edge are connected via a pair of sloping side walls;
the body forming at least one internal cavity coaxial with and extending the length of the body; and
a rope sized to fit within the at least one internal cavity.

15. The restraint system according to claim 14, wherein the body is comprised of a top portion and a bottom portion.

16. The restraint system according to claim 15, wherein the top portion and the bottom portion are slidably engaged.

17. The restraint system according to claim 15, wherein the bottom portion of the body is comprised of rubber.

18. The restraint system according to claim 15, wherein the top portion of the body is comprised of aluminum.

19. The restraint system according to claim 14, wherein the at least one internal cavity is sized to accommodate the rope such that each body is secured along a length of the rope using a knot on either side of each body.

20. The restraint system according to claim 19, wherein the rope is reflective.
